(19) United States
(12) Patent Application Publication
(10) Pub. No.: US 2023/0150265 A1
(43) Pub. Date: May 18, 2023

(54) LIQUID DISCHARGE APPARATUS AND WIPER USED IN LIQUID DISCHARGE APPARATUS

(71) Applicant: BROTHER KOGYO KABUSHIKI KAISHA, Nagoya (JP)

(72) Inventors: Kosuke TORIKAI, Nagoya (JP); Hirotoshi ISHIZAKI, Nagakute (JP); Sota MURAWAKA, Nagoya (JP)

(73) Assignee: BROTHER KOGYO KABUSHIKI KAISHA, Nagoya (JP)

(21) Appl. No.: 17/937,940

(22) Filed: Oct. 4, 2022

(30) Foreign Application Priority Data
Nov. 12, 2021 (JP) 2021-185042

(51) Int. Cl. B41J 2/165

(52) U.S. Cl. CPC B41J 2/16535; B41P 2235/20

(57) ABSTRACT

A liquid discharge apparatus includes: a head having a lower surface including a nozzle surface in which a nozzle is opened; a wiper making contact with the nozzle surface of the head and wiping the nozzle surface; and a driving part driving at least one of the wiper and the head to thereby cause the wiper to move relative to the head toward one side in a wiping direction in a state that the wiper makes contact with the nozzle surface. The wiper includes: a wiper body having a wiping part wiping the nozzle surface, and a projection projecting from the wiper body toward the other side in the wiping direction. After the wiping part of the wiper body is separated from an end part on the one side in the wiping direction of the nozzle surface, the projection makes contact with the lower surface of the head.

### REFERENCE TO RELATED APPLICATIONS

This application claims priority from Japanese Patent Application No. 2021-185042 filed on Nov. 12, 2021. The entire content of the priority application is incorporated herein by reference.

### BACKGROUND ART

A certain publicly known liquid discharge apparatus is provided with a head, a wiper which makes contact with a nozzle surface of the head and which wipes the nozzle surface, and a spring applying a force in an opposite direction to a restoring force, of the wiper, by which the wiper deformed by the contact with the nozzle surface of the head attempts to be restored to the original shape thereof, so as to weaken the restoring force. The spring is used so as to weaken the restoring force of the wipe, and to thereby suppress a restoring speed by which the wiper is restored, which in turn prevents an ink adhered to a forward end (tip end) of the wiper from scattering.

### DESCRIPTION

In the publicly known liquid discharge apparatus, even in a case that the forward end of the wiper makes contact with the nozzle surface of the head and wipes the nozzle surface, the spring pulls the wiper. Accordingly, a pressure generated in a case that the wiper makes contact with the nozzle surface is weakened as compared with a case that the spring is not provided, which in turn lowers the wiping performance of the wiper.

An object of the present disclosure is to provide a technique of suppressing any lowering in the wiping performance of the wiper while suppressing the scattering of the ink adhered to the forward end of the wiper.

According to an aspect of the present disclosure, there is provided a liquid discharge apparatus including: a head; a wiper; and a driving part. The head includes a lower surface including a nozzle surface in which a nozzle is opened. The wiper is configured to make contact with the nozzle surface of the head and to wipe the nozzle surface. The driving part is configured to drive at least one of the wiper and the head so as to cause the wiper to move relative to the head toward one side in a wiping direction in a state that the wiper makes contact with the nozzle surface. The wiper includes: a wiper body including a wiping part configured to wipe the nozzle surface; and a projection projecting from the wiper body toward the other side in the wiping direction. After the wiping part of the wiper body is separated from an end part on the one side in the wiping direction of the nozzle surface, the projection is configured to make contact with the lower surface of the head.

In the above-described configuration, the projection projects from the wiper body toward the other side in the wiping direction. Accordingly, while the wiper is (being) moved toward the one side in the wiping direction so that only the wiping part of the wiper body wipes the nozzle surface of the head, there is not any fear that the projection might make contact with the lower surface of the head and that the wiping performance of the wiping part might be lowered thereby. Further, the projection is configured to make contact with the lower surface of the head after the wiping part of the wiper body is separated from the end part on the one side in the wiping direction of the nozzle surface. With this, the projection is capable of suppressing the restoring force, of the wiper, by which the deformation of the wiper body is restored, after the wiping part of the wiper body is separated from the nozzle surface. Accordingly, it is possible to suppress the restoring speed of the wiper body and to thereby suppress the scattering of the ink adhered to the wiping part of the wiper body. Further, there is no need to separately provide a member different from the wiper in order to suppress the restoring force of the wiper body. With this, is it possible to suppress the manufacturing cost of the liquid discharge apparatus. Furthermore, the projection does not affect the deformation of the wiper body in a case that the wiper body wipes the nozzle surface. Accordingly, even in a case that the projection is formed in order to suppress the restoring force of the wiper body, there is no such a fear that the wiping performance of the wiper might be lowered.

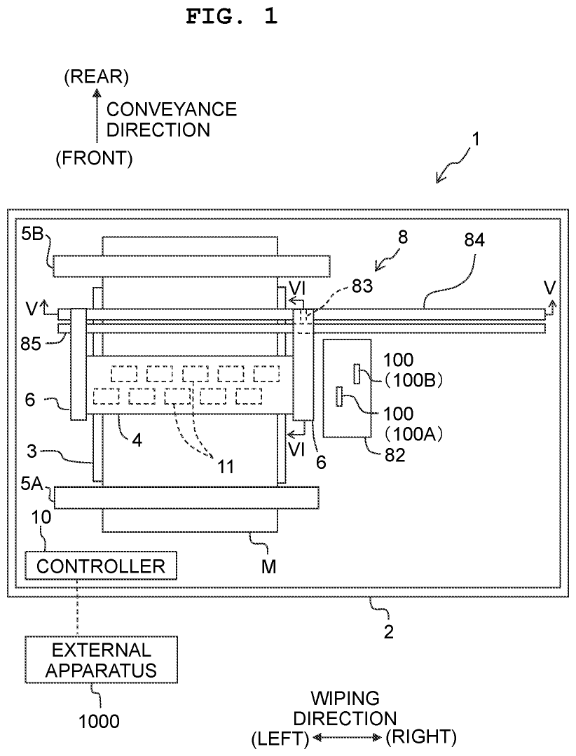

FIG. 1 is a plan view schematically depicting the configuration of an ink-jet printer.

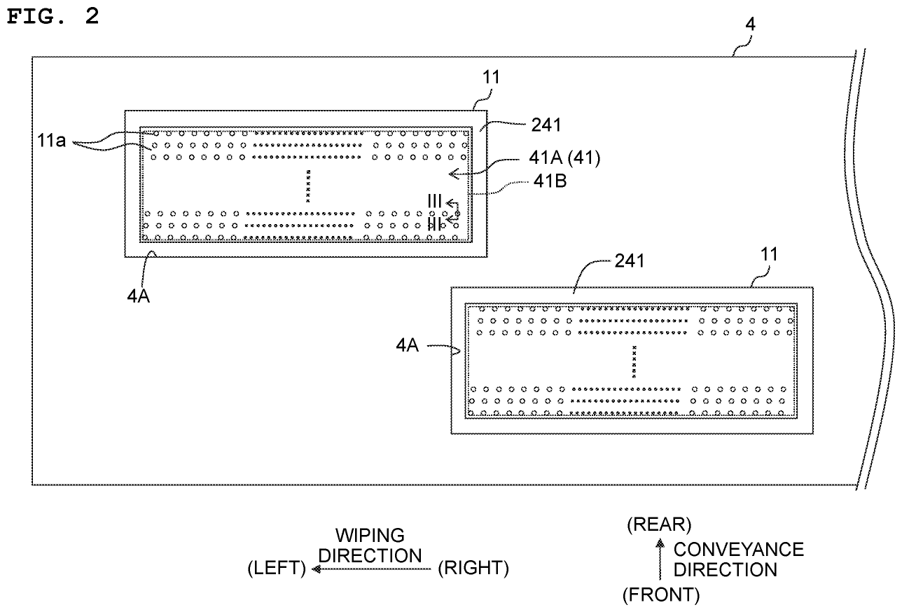

FIG. 2 is a bottom view depicting an example of a head of the ink-jet printer.

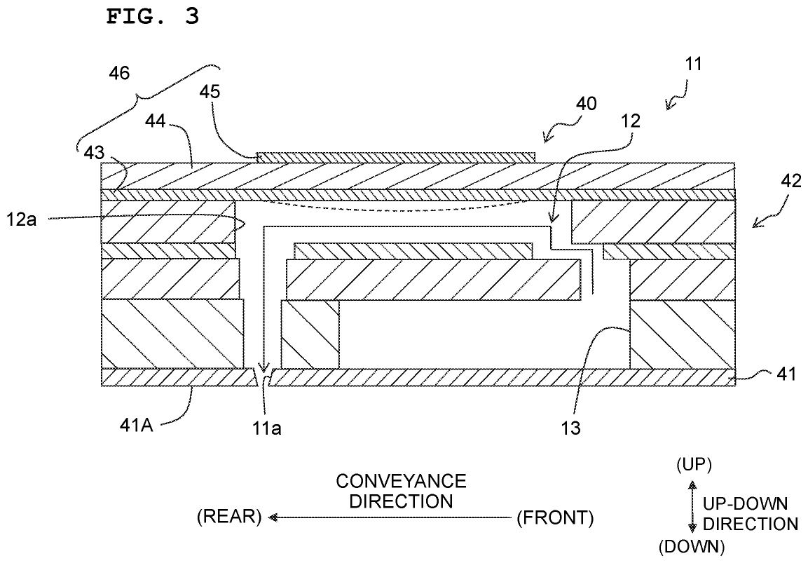

FIG. 3 is a cross-sectional view taken along a line in FIG. 2.

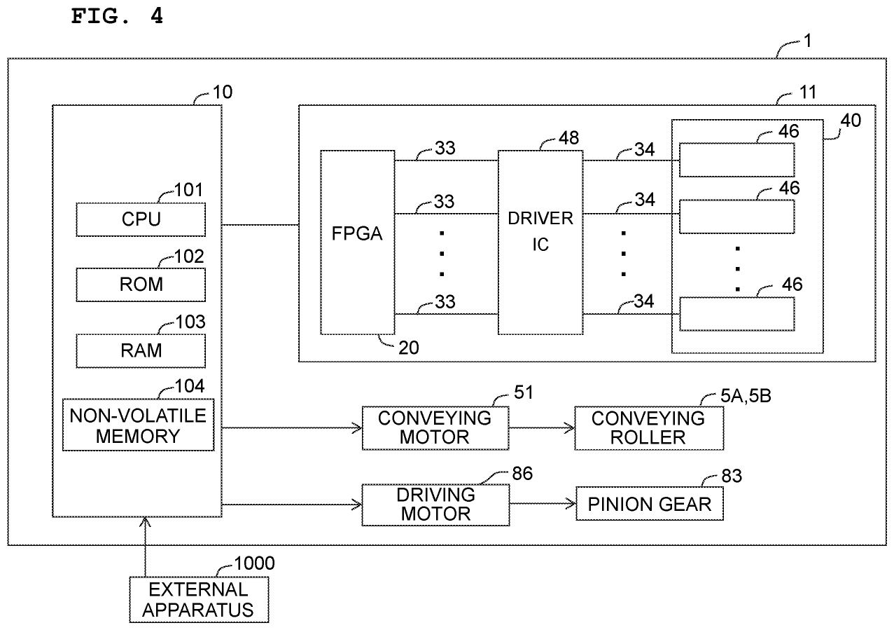

FIG. 4 is a block diagram schematically depicting the electric configuration in the ink-jet printer of the present embodiment.

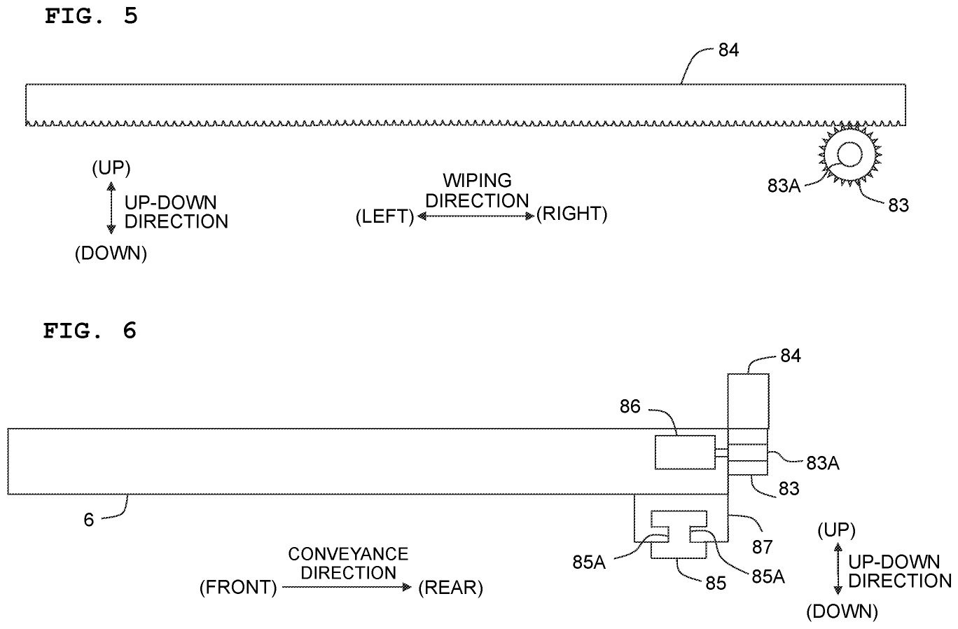

FIG. 5 is a cross-sectional view taken along a line V-V in FIG. 1.

FIG. 6 is a cross-sectional view taken along a line IV-IV in FIG. 1.

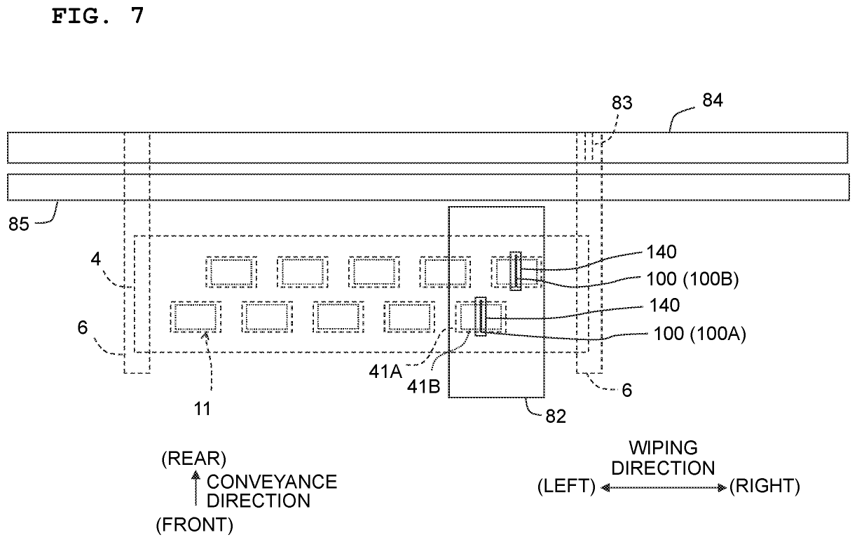

FIG. 7 is a view schematically explaining a positional relationship between the head and a wiper at a time of a wiping operation.

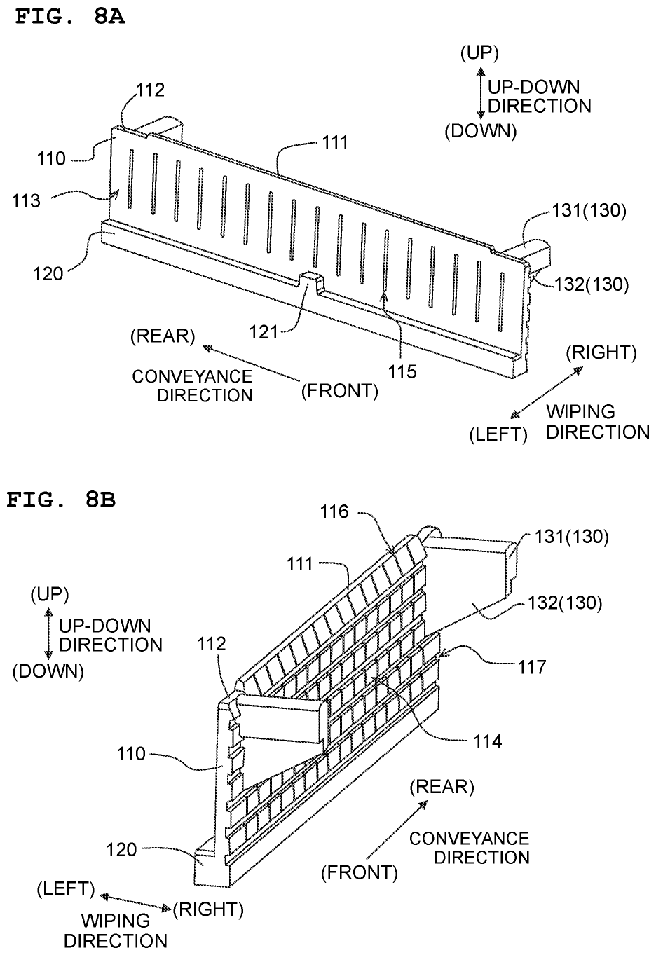

FIG. 8A is a view schematically explaining the wiper as seen from a side of a first surface, and FIG. 8B is a view schematically explaining the wiper as seen from a side of a second surface.

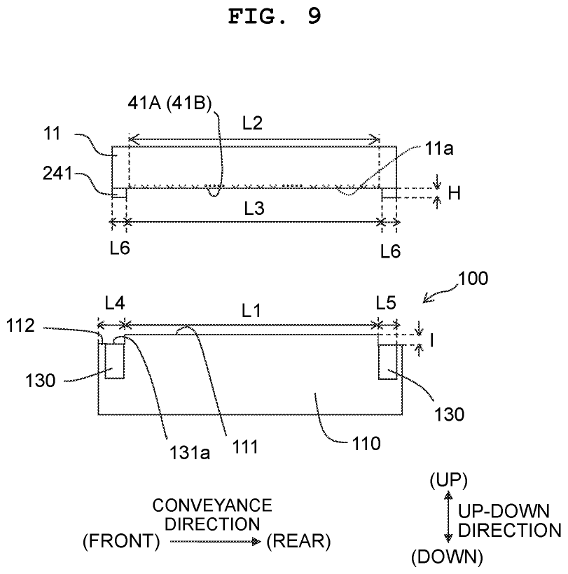

FIG. 9 is a view schematically explaining a positional relationship between a wiper body and the head.

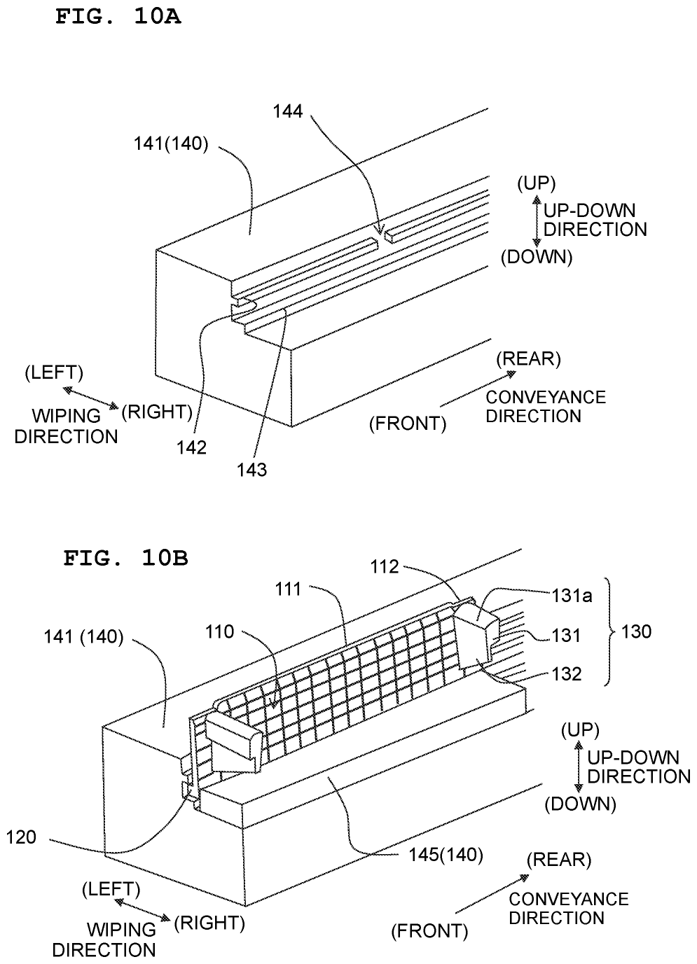

FIG. 10A is a view schematically explaining a fixing member, and FIG. 10B is a view schematically explaining a state that the wiper body is fixed to the fixing member.

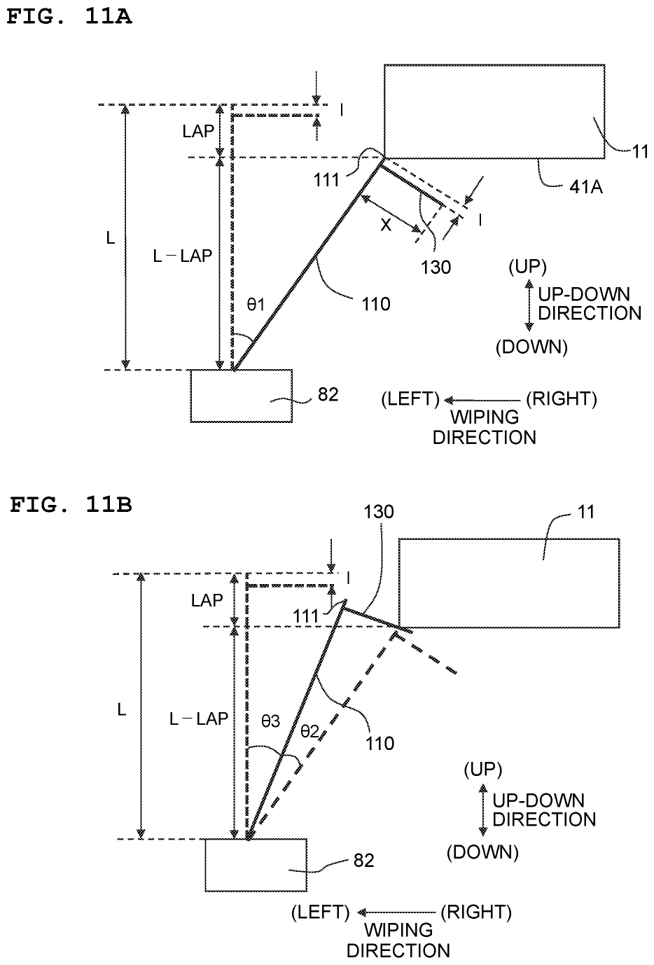

FIG. 11A is a view schematically explaining a state that an upper end of the wiper body makes contact with the lower surface of the head, and FIG. 11B is a view schematically explaining a state that a projection makes contact with the lower surface of the head.

In the following, an ink-jet printer 1 according to an embodiment of the present disclosure will be explained, with reference to the drawings.

In FIG. 1, the upstream side in a conveying direction of a medium M is defined as the front side of the ink-jet printer 1, and the downstream side in the conveying direction is defined as the rear side of the ink-jet printer 1. Further, a direction which is parallel to a plane or surface (conveyance plane or surface) in which the medium M such as print paper (print sheet, print paper sheet) is conveyed (a plane or surface parallel to the sheet surface of FIG. 1) and which is orthogonal to the conveying direction is defined as a wiping direction. The wiping direction coincides with a width direction of the medium M. As will be described later on, the wiping direction is a direction in which the head 11 is moved with respect to a wiper 100 in a case that a wiping operation is performed by using the wiper 100. One side of the wiping direction corresponds to the left side in a case that the ink-jet printer 1 is seen from the front side (the left side in FIG. 1), and the other side of the wiping direction corresponds to the right side in a case that the ink-jet printer 1 is seen from the front side (the right side in FIG. 1). Further, a direction orthogonal to the conveyance plane of the medium M (a direction orthogonal to the sheet surface of FIG. 1) is defined as the up-down direction of the ink-jet printer. In FIG. 1, a side to which the front surface of the sheet is oriented or faces is the upper side, and a side to which the rear surface of the sheet is oriented or faces is the lower side. In the following explanation, the front (front side), the rear (rear side), the left (left side), the right (right side), the up (upper side) and the down (lower side) are appropriately used.

As depicted in FIG. 1, the ink-jet printer 1 is provided with a casing 2, a platen 3, a head bar 4, conveying rollers 5A and 5B, a head holder 6, a maintenance system 8 and a controller 10. Note that the ink-jet printer 1 is an example of a “liquid discharge apparatus”. The configuration in which the head bar 4 and the maintenance system 8 are combined is an example of a “head bar system”.

As depicted in FIG. 1, the head holder 6 is arranged in the casing 2 so that the head holder 6 is movable in the wiping direction. The head holder 6 is arranged to sandwich, in the wiping direction, the both sides of the platen 3. The head bar 4 is fixed to the head holder 6. The head bar 4 is arranged at a location above the platen 3 so that a predetermined spacing distance is formed (defined) between the head bar 4 and the platen 3. The medium M which is, for example, paper, etc., is conveyed on the upper surface of the platen 3.

As depicted in FIG. 1, the head bar 4 is provided with 10 pieces of an ink-jet head 11 (hereinafter simply referred to as the “head(s) 11”. The ten heads 11 are arranged to form two rows along the wiping direction. Further, five heads 11, among the ten heads 11, which construct each of the two rows are arranged with equal spacing distances therebetween in the wiping direction. The two rows of the heads 11 are arranged to be shifted from each other in the wiping direction. Namely, the five heads 11 arranged on the upstream side in the conveying direction (the front side) are arranged to be shifted toward one side in the wiping direction (leftward) with respect to the five heads 11 arranged on the downstream side in the conveying direction (the rear side). In other words, the ten heads 11 are arranged in the staggered manner in the wiping direction. In the present embodiment, an ink supplied from a non-illustrated ink supplying part is discharged or ejected from each of the heads 11.

The conveying roller 5A is arranged on the front side with respect to the platen 3, and the conveying roller 5B is arranged on the rear side with respect to the platen 3. Each of the conveying rollers 5A and 5B is driven by a non-illustrated motor, and conveys the medium M on the platen 3 rearward. Note that the medium M may be a roll-shaped sheet including a supply roll arranged on the upstream side in the conveying direction with respect to the platen 3, and a recovery roll arranged on the downstream side in the conveying direction with respect to the platen 3. In such a case, the medium M which is fed out from the supply roll passes on the platen 3, and then is wound around (is taken up by) the recovery roll. Note that the supply roll may be attached to the conveying roller 5A, and that the recovery roll may be attached to the conveying roller 5B. Alternatively, the medium M may be a roll-shaped sheet including only a supply roll arranged on the upstream side in the conveying direction with respect to the platen 3. In this case, the supply roller may be attached to the conveying roller 5A.

The maintenance system 8 is arranged, in the inside of the casing 2, at a location between the platen 3 and the head bar 4 regarding the up-down direction. As depicted in FIG.1, the maintenance system 8 is mainly provided with two wipers 100, a maintenance base 82, a pinion gear 83, a rack gear 84, a guide 85, a driving motor 86 (see FIG. 4) and an engaging block 87 (see FIG. 6). In a case that maintenance is performed, the wiper 100 is caused to wipe a lower surface (a nozzle surface 41A and a lower surface of a nozzle cover 241 (see FIG. 2) which will be described later on) of each of the heads 11 while moving the head holder 6 (and the head bar 4) along the rack gear 84 toward the one side (right side) in the wiping direction. As depicted in FIG. 1, the rack gear 84 extends up to the right side with respect to (beyond) the maintenance base 82. In a case that the maintenance is not performed, the head bar 4 is arranged at a position at which the head bar 4 does not interfere with the maintenance base 82 on the left side with respect to the maintenance base 82 (stand-by position, printing position). The detailed configuration of the maintenance system 8 will be described later on.

The controller 10 is capable of mutually communicating with an external apparatus 1000 such as a personal computer, etc. The controller 10 controls the operations of the respective heads 11 included in the head bar 4, the conveying rollers 5A and 5B and the maintenance system 8, based on an instruction from the external apparatus 1000 or an instruction from a user via an operating part (not depicted) provided on the ink-jet printer 1.

Next, the lower surface of the head bar 4 and the lower surface of each of the heads 11 will be explained, with reference to FIG. 2. Note that FIG. 2 depicts only a head 11 which is arranged rightmost among the five heads 11 arranged on the upstream side in the conveying direction and a head 11 which is arranged rightmost among the five heads 11 arranged on the downstream side in the conveying direction, and remaining heads 11 other than these two heads 11 are omitted in the illustration.

A bottom surface of each of the heads 11 faces or is opposite to the platen 3. Further, a nozzle surface 41A in which 1680 pieces of a nozzle 11a are opened is included in the bottom surface of each of the heads 11. In the nozzle surface 41A, the 1680 nozzles 11a form 24 pieces of a nozzle row arranged side by side in the conveying direction. Furthermore, each of the 24 nozzle rows includes 70 pieces of the nozzle 11a arranged side by side in the wiping direction with equal spacing distances therebetween. Each of the 70 nozzles 11a constructing one of the nozzle rows is arranged to be shifted in the wiping direction with respect to one of the 70 nozzles 11a constructing another nozzle row adjacent thereto in the conveying direction. In the following explanation, a virtual area which is an area which is on the inner side with respect to an outer edge of the nozzle surface 41A of each of the heads 11 and which includes all the nozzles 11a formed in the nozzle surface 41A in the inside of the area is referred to as a nozzle formation area 41B. Further, each of the heads 11 has a nozzle cover 241 which is arranged therein and which is configured to cover the nozzle 41A from therebelow so as to surround the nozzle formation area 41B of the nozzle surface 41A (see FIGS. 2 and 9). As depicted in FIG. 9, the lower surface of the nozzle cover 241 protrude downward beyond the nozzle surface 41A. In the following explanation, the lower surfaces of the nozzle surface 41A and the nozzle cover 241 are collectively referred to as the “lower surface” of the head 11, in some cases.

Ten pieces of an opening 4A corresponding to the ten heads 11, respectively, are formed in the lower surface of the head bar 4. The ten openings 4A are arranged in two rows in the staggered manner along the wiping direction. Five openings 4A included in the ten openings 4A and constructing each of the two rows are arranged in the wiping direction with equal spacing distances therebetween. As depicted in FIG. 2, each of the openings 4A has a size which is substantially same as the lower surface of one of the heads 11; and the nozzle cover 241 and the nozzle surface 41A (nozzle formation area 41B) of each of the heads 11 is exposed from one of the openings 41A corresponding thereto. Note that in the present embodiment, although not depicted in the drawings, the lower surface of the head bar 4 is flush with the nozzle surface 41A of each of the heads 11, and a lower end of the nozzle cover 241 of each of the heads 11 projects downward beyond the lower surface of the head bar 4. Note that it is not necessarily indispensable that the lower surface of the head bar 4 is flush with the nozzle surface 41A of each of the heads 11. For example, it is allowable that the nozzle surface 41A of each of the heads 11 protrudes downward beyond the lower surface of the head bar 4.

Next, a channel unit 42 and an actuator unit 40 constructing each of the heads 11 will be explained, with reference to FIGS. 2 to 4. Note that since the configurations of the channel unit 42 and the actuator unit 40 are common to the ten heads 11, the explanation will be given about the channel unit 42 and the actuator unit 40 in one piece of the head 11.

As depicted in FIG. 3, the channel unit 42 is formed of a plurality of metal plates and a nozzle plate 41 which are stacked in the up-down direction. An ink channel such as individual channels 12 which include pressure chambers 12a, respectively, a manifold 13, etc., is formed in the plurality of metal plates by the etching. The nozzle plate 41 is formed, for example, of a polymeric synthetized resin material such as polyimide, etc., and is adhered to a lower surface of the stacked metal plates with an adhesive. A lower surface of the nozzle plate 41 becomes to be the above-described nozzle surface 41A. Note that it is allowable that the nozzle plate 41 is also formed of a metallic material such as stainless steel, etc.

As depicted in FIG. 3, the individual channels 12 each of which communicates with one of the nozzles 11a, and the manifold 13 communicating with the individual channels 12 are formed in the inside of the channel unit 42. Although not depicted in the drawings, the manifold 13 extends in the wiping direction (in FIG. 3, a direction perpendicular to the sheet surface). The ink is supplied, via a non-illustrated ink supply port formed in the channel unit 42, to the manifold 13 from a non-illustrated ink supplying part which is provided at the outside of the head 11.

Note that although not depicted in the drawings, 1680 pieces of the individual channel 12 are arranged so as to form 24 individual channel rows extending in the wiping direction, in corresponds to that the 1680 nozzles 11a are arranged so as to form the 24 nozzle rows extending in the wiping direction, as described above. Further, 12 pieces of the manifold 13 are provided on the channel unit 24; each of the 12 manifolds 13 communicates with 140 individual channels 12, among the 1680 individual channels 12, constructing two individual channel rows among the 24 individual channel rows. With this, in the inside of the channel unit 42, a plurality of ink channels are formed, each of the plurality of ink channel starting from the manifold 13, passing the pressure chamber 12a of one of the plurality of individual channels 12, and reaching one of the nozzles 11a. Note that the number (quantity) of the manifold 13 formed in the channel unit 42 and the number (quantity) of the individual channel 12 communicating with the manifold 13 are not limited to or restricted by the above-described numbers (quantities).

As depicted in FIG. 3, one of the pressure chambers 12a is formed in each of the individual channels 12, and the actuator unit 40 is arranged at a location above the pressure chambers 12a. The actuator unit 40 is provided with a vibration plate 43 arranged on the upper surface of the channel unit 42 so as to cover all the pressure chambers 12a, a piezoelectric body 44 arranged to cover the entire surface (entirety) of the upper surface of the vibration plate 43, and 1680 individual electrodes 45 each of which is arranged, on the upper surface of the piezoelectric body 44, at a position facing one of the pressure chambers 12a. As will be described later on, the vibration plate 43 functions as a common electrode. The vibration plate 43 as the common electrode, each of the individual electrodes 45, and a part, of the piezoelectric body 44, which is sandwiched by one of the individual electrodes 45 and the vibration plate 43 form one piece of a driving element 46. Namely, the actuator unit 40 includes 1680 pieces of the driving element 46.

The vibration plate 43 is a metallic plate which has a substantially rectangular shape in a plan view, and is formed of an iron-based alloy such as stainless steel, a copper-based alloy, a nickel-based alloy, or a titanium-based alloy, etc. The upper surface of the vibration plate 43 having the electric conductivity is arranged on the side on which the lower surface of the piezoelectric body 44 is located. Accordingly, the upper surface of the vibration plate 43 is capable of functioning also as the common electrode. The vibration plate 43 as the common electrode is connected to a ground wiring of a driver IC 48 (see FIG. 4) which drives the actuator unit 40, and is maintained to be the ground potential at all times. Note that it is not necessarily indispensable that the vibration plate 43 is the metallic plate; for example, it is allowable that the vibration plate 43 is formed of a piezoelectric material which is same as that forming the piezoelectric body 44, and that a metallic film as the common electrode is formed on the upper surface of the vibration plate 43.

The piezoelectric body 44 is formed of a piezoelectric material composed primarily of lead zirconate titanate (PZT) which is a solid solution of lead titanate and lead zirconate and which is a ferroelectric substance. The piezoelectric body 44 is polarized in a thickness direction (up-down direction) at least at an area facing the pressure chamber 12a (a part sandwiched between the individual electrode 45 and the vibration plate 43). In the present embodiment, a layer of the piezoelectric body (piezoelectric layer) which is formed continuously across the plurality of pressure chambers 12a is formed on the upper surface of the vibration plate 43. It is allowable, however, that 1680 pieces of an independent (separate) piezoelectric body 44 are provided, each corresponding to one of the 1680 pieces of the pressure chamber 12a.

As depicted in FIG. 3, each of the individual electrodes 45 is arranged at an area, of the upper surface of the piezoelectric body 44, which faces one of the pressure chambers 12a. Each of the individual electrodes 45 is electrically connected to the driver IC 48 (see FIG. 4) mounted on a non-illustrated flexible wiring (COF), via a signal line 34 (see FIG. 4). As depicted in FIG. 4, the driver IC 48 is electrically connected to the controller 10. The driver IC 48 applies a driving pulse signal to the individual electrode 45 of the driving element 46, based on a signal transmitted from the controller 10. With this, the driver IC 48 applies either one of a predetermined driving potential and the ground potential selectively to each of the individual electrodes 45.

Next, an explanation will be given about an action of the driving element 46 of the actuator unit 40 at a time of ink discharge (ink ejection). In a case that the predetermined driving potential is applied from the driver IC 48 to a certain individual electrode 45 included in the individual electrodes 45, a potential difference is generated between the certain individual electrode 45 to which the driving potential is applied and the vibration plate 43 as the common electrode and maintained at the ground potential. With this, an electric field in the thickness direction is generated at the part, of the piezoelectric body 44, sandwiched between the certain individual electrode 45 and the vibration plate 43. The direction of the electric filed is parallel to the polarization direction of the piezoelectric body 44. Accordingly, due to this electric field, an area (active area), of the piezoelectric body 44, which faces the certain individual electrode 45 contracts in a plane direction orthogonal to the thickness direction. Here, the vibration plate 43 which is on the lower side of the piezoelectric body 44 is fixed to the channel unit 42. Accordingly, accompanying with the active area, of the piezoelectric body 44, which is positioned on the upper surface of the vibration plate 43 contracting in the plane direction, a part of the vibration plate 43 which covers the pressure chamber 12a is deformed so as to project toward the pressure chamber 12a (unimorph deformation, see FIG. 3). In this situation, since the volume inside the pressure chamber 12a is reduced, the pressure of the ink inside a certain pressure chamber 12a, among the pressure chambers 12, corresponding to the certain individual electrode 45 is increased, thereby discharging the ink from a nozzle 11a, among the nozzles 11a, communicating with the certain pressure chamber 12a.

Next, an explanation will be given about the schematic electric configuration of the ink-jet printer 1, with reference to FIG. 4. The controller 10 is electrically connected to each of the heads 11. The controller 10 is mainly provided with a CPU (Central Processing Unit) 101, a ROM (Read Only Memory) 102, a RAM (Random Access Memory) 103, and a non-volatile memory 104. The ROM 102 stores a program(s), a variety of kinds of data, etc., with which the CPU controls a variety of kinds of operations. The RAM 103 is used as a memory area configured to temporarily store data, signal, etc., to be used by the CPU 101 for executing the program, or is used as a workspace for executing data processing. It is allowable to use, as the non-volatile memory 104, for example, an EEPROM (Electrically Erasable Programmable Read-Only Memory). Note that it is allowable to use a 1VIPU (Microprocessor Unit) or a FPGA (Field Programmable Gate Array), rather than using the CPU 101.

As depicted in FIG. 4, each of the heads 11 has a FPGA 20 and the driver IC 48, in addition to the actuator unit 40 including the 1680 driving elements 46. The FPGA 20 is connected to the drive IC 48 by a wiring 33 for control signal. Further, the driver IC 48 is connected to each of the driving elements 46 by a wiring 48 for driving signal.

In a case that the controller 10 receives image data from the external apparatus 1000, the FPGA 20 outputs a control signal via the wiring 33 for control signal, under the control by the controller 10. The driver IC 48 generates a driving signal for driving the actuator unit 40 based on the control signal inputted from the FPGA 20, and outputs the generated driving signal to the actuator unit 40 via the wiring 34 for driving signal.

Further, a certain driving element 46, among the driving elements 46, is driven based on the driving signal supplied from the driver IC 48, the ink is thereby discharged from a certain nozzle 11a, among the nozzles 11a, corresponding to the certain driving element 46, in an amount corresponding to the driving signal.

Furthermore, the controller 10 is electrically connected to a conveying motor 51, and controls the driving of the conveying motor 51 to thereby control the conveyance of the medium M by the conveying rollers 5A and 5B. Moreover, the controller 10 is electrically connected to the driving motor 86, and controls the driving of the driving motor 86 to thereby control the movement of the head bar 4 in the wiping direction via the pinion gear 83.

Next, the maintenance system 8 provided on the ink-jet printer 1 according to the present embodiment will be explained.

As depicted in FIGS. 1, 5 and 7, the rack gear 84 extends in the wiping direction. The rack gear 84 is arranged in the inside of the casing 2 (see FIG. 1). As depicted in FIG. 5, teeth meshing or engaging with the pinion gear 83 are formed in the lower surface of the rack gear 84. As depicted in FIG. 7, a length in the wiping direction of the rack gear 84 is longer than a length in the wiping direction of an area, of the head bar 4, in which the ten heads 11 are arranged (hereinafter referred to as a “head arrangement area”).

As depicted in FIG. 1, the guide 85 extends in the wiping direction, and is arranged in the inside of the casing 2. As depicted in FIG. 6, the guide 85 is arranged at a location below the rack gear 84 and the head holder 6. Guide grooves 85A are formed in side surfaces, respectively, which are on the both sides in the conveying direction of the guide 85. A cross sectional shape of each of the guide grooves 85 is substantially rectangular, and each of the guide grooves 85A extends in the wiping direction (direction perpendicular to the sheet surface of FIG. 6). Note that as depicted in FIG. 7, a length in the wiping direction of the guide 85 is also longer than the length in the wiping direction of the head arrangement area in the head bar 4.

The maintenance base 82 has a shape of a rectangular parallelepiped. As depicted in FIG. 7, a length in the conveying direction of the maintenance base 82 is longer than a length in the conveying direction of the head arrangement area in the head bar 4. Further, as depicted in FIG. 6, a pinion gear 83 which protrudes rearward is provided on a side surface on one side in the conveying direction (rear side) of the head holder 6, and the driving motor 86 connected to a rotation shaft 83A of the pinion gear 83 is fixed to the inside of the maintenance base 82. As depicted in FIGS. 5 and 6, the rotation shaft 83A of the pinion gear 83 extends in the conveying direction, and teeth meshing with the teeth of the rack gear 84 are formed in a circumferential surface of the pinion gear 83. Further, an engaging block 87 is provided on a location, in the lower surface of the head holder 6, which is on the one side in the conveying direction (rear side). The engaging block 87 engages with the guide grooves 85A of the guide 85, while the pinion gear 83 meshes or engages with the rack gear 84, thereby supporting the head holder 6. Note that the positions in the up-down direction of the rack gear 84, the guide 85 and the head holder 6 can be adjusted to a wiping position and to a retreating (retracting) position, by a non-illustrated lifting and lowering mechanism. The wiping position is a position at which an upper end 111 of the wiper 100 (to be described later on) is located above the nozzle surface 41A (nozzle formation area 41B) of the head 11. The retreating position is a position at which the upper end 111 of the wiper 100 is located below the nozzle surface 41A (nozzle formation area 41B) of the head 11.

As depicted in FIG. 1, the two wipers 100 are attached to the upper surface of the maintenance base 82. Each of the two wipers 100 includes a member which is integrally formed by an EPDM rubber (a wiper body 110, a base part 120 and a projection 130 which will be described later on). The EPDM rubber has the hardness of not less than 70 degrees, and has a property which is less likely to swell by the ink. The shape of each of the two wipers 100 will be described later on. As depicted in FIGS. 1 and 7, positions in the wiping direction of the two wipers 100 are shifted from each other. Specifically, a wiper 100 (hereinafter referred to as a “wiper 100A”) included in the two wipers 100 and arranged on the upstream side in the conveying direction is arranged to shift to the one side in the wiping direction (to the left side, leftward) with respect to a wiper 100 (hereinafter referred to as a “wiper 100B”) included in the two wipers 100 and arranged on the downstream side in the conveying direction. Further, as depicted in FIG. 7, the wiper 100A is attached to the upper surface of the maintenance base 82 so that the nozzle formation area 41B of each of the five heads 11 on the upstream side in the conveying direction (front side) is positioned between the both ends in the conveying direction of the wiper 100A. Similarly, the wiper 100B is attached to the upper surface of the maintenance base 82 so that the nozzle formation area 41B of each of the five heads 11 on the downstream side in the conveying direction (rear side) is positioned between the both ends in the conveying direction of the wiper 100B.

In a case that the pinion gear 83 rotates in normal and reverse directions in accordance with the driving of the driving motor 86, the head holder 6 thereby moves in a reciprocal manner along the rack gear 84 and the guide 85 in the wiping direction. The head holder 6, the driving motor 86, the pinion gear 83, the rack gear 84 and the guide 85 correspond to a “driving part” of the present disclosure. As will be described later on, in a state that the head holder 6 is moved to the maintenance position by the non-illustrated liftin-lowering mechanism, the head holder 6 is moved toward the right side in the wiping direction, thereby making it possible to perform a wiping operation of wiping the ink adhered to the nozzle formation area 41B of the head 11. In this situation, as depicted in FIG. 7, the upper end 111 (see FIGS. 8A and 8B) of the wiper 100A successively makes contact with the nozzle formation areas 41B of the respective five heads 11 on the upstream side in the conveying direction, and wipes off the ink adhered to the nozzle formation areas 41B. Similarly, the upper end 111 (see FIGS. 8A and 8B) of the wiper 100B successively makes contact with the nozzle formation areas 41B of the respective five heads 11 on the downstream side in the conveying direction, and wipes off the ink adhered to the nozzle formation areas 41B. Namely, each of the wiper 100A and the wiper 100B is capable of wiping a plurality of pieces of the nozzle formation area 41B which are aligned in the wiping direction. In the maintenance system 8 of the present disclosure, since each of the wipers 100 is capable of wiping the plurality of pieces of the nozzle formation area in such a manner, it is possible to wipe the plurality of nozzle formation areas efficiently, and to shorten the time required for the maintenance.

Next, the shape of the wiper 100 will be explained, with reference to FIGS. 8A, 8B, 9, 10A and 10B. As depicted in FIGS. 8A and 8B, the wiper 100 is provided with a wiper body 110, a base part 120, two projections 131 and a fixing member 140 (see FIGS. 7, 10A and 10B). The wiper body 110 is a plate-like member elongated in the conveying direction. The wiper body 110 has a thickness in the wiping direction which becomes thinner further toward the upper side. A plurality of grooves 115 extending in the up-down direction are formed in a surface 113 (hereinafter referred to as a “first surface 113”) on the one side in the wiping direction (left side) of the wiper body 110. A plurality of grooves 116 extending in the up-down direction and a plurality of grooves 117 extending in the conveying direction are formed in a surface 114 (hereinafter referred to as a “second surface 114”) on the other side in the wiping direction (right side) of the wiper body 110. Stepped parts 112 of which height in the up-down direction is lower than the upper end 111 are formed, respectively, on both sides in the conveying direction of the upper end 111 of the wiper body 110. The upper end 111 is an example of a “first area” of the present disclosure, and the stepped parts 112 are each an example of a “second area” of the present disclosure. In a case that the wiper 100 is at the wiping position, the upper end 111 makes contact with the nozzle surface 41 of the head 11, and the stepped parts 112 make contact with the nozzle cover 241 of the head 11, as will be described later on.

As depicted in FIG. 8A, the base part 120 is provided on a lower end of the first surface 113 of the wiper body 110. The thickness (length in the wiping direction) of the base part 120 is greater than the thickness of the wiper body 110. A projecting part 121 which projects in the up-down direction is formed at a central part in the conveying direction of the base part 120.

As depicted in FIG. 8B, two projections 130 which project toward the other side (right side) in the wiping direction are formed in the second surface 114 of the wiper body 110. In the present embodiment, the two projections 130 are arranged in the conveying direction with a spacing distance therebetween so that an inner side end in the conveying direction of each of the two projections 130 is located at a position which is same as one of the ends on the both sides in the conveying direction of the upper end 111 of the wiper body 110 (see FIG. 9). In other words, each of the two projections 130 projects, in the second surface 114 of the wiper body 110, from one of the stepped parts 112 toward the other side in the wiping direction (right side). Each of the projections 130 has a base 131 having a substantially rectangular parallelepiped shape and extending perpendicularly from the second surface 114, and a supporting part 132 which spreads downward from a lower end of the base 131. Note that an upper surface 131a of the base 131 is flush with one of the stepped parts 112 of the wiper body 110. As will be described later on, in a case that the wiper 100 is at the wiping position, the upper surface 131a of the base 131 makes contact with the nozzle cover 241 of the head 11. The upper surface 131a of the base 131 is an example of a “contact surface” of the present disclosure.

As depicted in FIG. 8B, a thickness in the conveying direction of the base 131 is greater than a thickness in the conveying direction of the supporting part 132. An upper end of the supporting part 132 is continuously connected to a lower end of the base 131, and a left end of the supporting part 132 is continuously connected to the second surfaced 114 of the wiper body 110. A lower end of the supporting part 132 is located at a position lower than the center in the up-down direction of the second surface 114. The supporting part 132 has a trapezoidal shape as seen in the conveying direction, and a length in the wiping direction of the supporting part 132 becomes longer further downward from the lower end of the base 131. Further, a length in the up-down direction of the supporting part 132 becomes shorter as separating further away from the second surface 114 of the wiper body 110 toward the right side.

As depicted in FIG. 9, a width L1 in the conveying direction of the upper end 111 of the wiper body 110 is greater than a length L2 in the conveying direction of the nozzle formation area 41B of each of the heads 11, and is slightly smaller than an inner width L3 of the nozzle cover 241. Accordingly, in a case that the wiper 100 is positioned at the wiping position, the upper end 111 of the wiper body 100 is capable of making contact with the nozzle surface 41B, without interfering with the nozzle cover 241. Further, the width L1 in the conveying direction of the upper end 111 of the wiper body 100 is greater than the length L2 in the conveying direction of the nozzle formation area 41B of each of the heads 11. Accordingly, during the wiping operation, the upper end 111 of the wiper body 110 is capable of wiping the entirety of the nozzle formation area 41B. Furthermore, a depth 1 in the up-down direction of the stepped parts 112 is substantially same as a height H in the up-down direction of the nozzle cover 241. Moreover, as described above, the upper surface 131a of the base 131 is flush with the stepped parts 112 of the wiper body 110. Accordingly, in the case that the wiper 100 is positioned at the wiping position, the stepped parts 112 of the wiper body 100 and the upper surface 131a of the base 131 are capable of making contact with the nozzle cover 241. Further, a width L4 in the conveying direction of the stepped parts 112 and a width L5 in the conveying direction of the upper surface 131a of the base 131 are greater than a length L6 in the conveying direction of the nozzle cover 241. Accordingly, at the time of the wiping, the stepped parts 112 and the upper surface 131a of each of the projections 130 are capable of wiping the entirety of the nozzle cover 241.

The fixing member 140 is a member configured to fix the wiper body 110 to the maintenance base 82. As depicted in FIG. 10B, the fixing member 140 is provided with a first member 141 and a second member 145 which are fixable to the first member 141. Note that the first member 141 is fixed to the maintenance base 82 (see FIG. 7). As depicted in FIG. 10A, the first member 141 is a member having a cross section which is substantially a shape of a letter “L”, and elongated in the conveying direction. Two projecting bars 142 and 143 extending in the conveying direction are formed in a surface on the right side in the wiping direction of the first member 141. The projecting bar 142 is positioned above the projecting bar 143, and the projecting bars 142 and 143 are arranged with a spacing distance in the up-down direction. The projecting bar 142 is formed to have a discontinued gap 144 at a part in the conveying direction thereof. As depicted in FIG. 10B, it is possible to fix the wiper body 110 to the fixing member 140 by causing the base member 120 provided on the lower part of the wiper body 110 to be sandwiched between the first member 141 and the second member 145 in a state that the base part 120 is inserted between the two projecting bars 142 and 143. Since the base part 120 is inserted between the two projecting bars 142 and 143, there is no fear that the wiper body 110 might be deviated in the up-down direction. Further, although not depicted in the drawings, the projecting part 121 of the base part 120 engages with the gap 144 provided on the projecting bar 142. With this, there is not such a fear that the wiper body 110 might be deviated in the conveying direction.

Next, the deformation of the wiper 100 during the wiping operation will be explained, with reference to FIGS. 11A and 11B.

As depicted in FIG. 11A in a dotted line, in a case that the wiper body 110 and the projection 130 do not make contact with the lower surface of the head 11, the wiper body 110 stands vertically with respect to the maintenance base 82 so that the wiper body 110 is parallel to the up-down direction. A length L in the up-down direction (hereinafter referred to as a height L) of the wiper body 110 is greater than the distance in the up-down direction between the maintenance base 82 and the nozzle surface 41A of the head 11. In the case that the wiper body 110 do not make contact with the lower surface of the head 11, the wiper body 110 and the head 11 overlap with each other in the up-down direction by an amount corresponding to a length LAP. Namely, the upper end 111 of the wiper body 110 is located above the nozzle surface 41A of the head 11 by the length LAP. In this situation, a length of a part, which is included in the wiper body 110 and which does not overlap with the head 11 in the up-down direction, can be expressed as: length L-LAP. Note that the distance in the up-down direction between the upper end 111 of the wiper body 110 and the projection 130 is referred to as a distance 1. As described above, since the upper surface 131a of the projection 130 and the stepped parts 112 are flush with each other, the distance 1 corresponds to the depth in the up-down direction of the stepped parts 112 (see FIG. 9).

As depicted in a solid line in FIG. 11A, in a case that the upper end 111 of the wiper body 110 makes contact with the nozzle surface 141A, the wiper body 110 is deformed to be inclined by an angle θ1 toward the other side in the wiping direction (right side), as compared with the case that the upper end 111 of the wiper body 110 does not make contact with the nozzle surface 141A. Note that the angle θ1 can be expressed as: θ1=arccos ((L-LAP)/L)[rad]. Note that since the projection 130 projects perpendicularly from the wiper body 110 toward the other side in the wiping direction (right side), the projection 130 does not make contact with the lower surface of the head 11 in a case that the upper end 111 of the wiper body 110 makes (is making) contact with the nozzle surface 41A. In other words, in a case that the wiper body 110 makes (is making) contact with the nozzle surface 31A of the head 11 and is thereby (being) deformed, the projection 130 does not hinder the wiper body 110 from being deformed.

Here, such a case is presumed that the projection 130 is not provided on the wiper 100. In a case that the wiper 100 moves, with respect to the head 11, toward the one side in the wiping direction (left side) and that the upper end 111 of the wiper body 110 is separated from the nozzle surface 41A, the wiper body 110 is abruptly restored to a parallel state in which the wiper body 110 is parallel to the up-down direction. Namely, the wiper body 110 is consequently restored to be inclined by the angle θ1 toward the one side in the wiping direction (left side). In this situation, there is such a fear that the ink which has been wiped from the nozzle surface 41a by the wiping operation and adhered to the first surface 113 of the wiper body 110 might be scattered in the surrounding due to the abrupt restoration of the wiper body 110.

In view of this, the projection 130 is provided on the wiper 100 in the present embodiment. In this case, as depicted by the solid line in FIG. 11B, in the case that the wiper 100 moves, with respect to the head 11, toward the one side in the wiping direction (left side) and that the upper end 111 of the wiper body 110 is separated from the nozzle surface 41A, the projection 130 makes contact with the lower surface of the head 11 (for example, the lower surface of the nozzle cover 241) before the wiper body 110 becomes to be parallel to the up-down direction. With this, in an instant that the upper end 111 of the wiper body 110 is separated from the nozzle surface 41A, the wiper body is restored toward the one side in the wiping direction (left side) only by an angle θ2 (θ2<θ1), rather than by the angle θ1. Here, the angle θ2 can be expressed as: θ2=arccos ((L-1)/L)[rad]. Further, provided that a distance along the projection 130 between the wiper body 110 and a contact point between the projection 130 and the head 11 in the case that the projection 130 makes contact with the lower surface of the head 11 is expressed as “X”, the X can be expressed as: X=L.sin θ2. The distance X corresponds to a height of the projection 130 from the wiper body 110 which is required in a case of determining the height L of the wiper body 110, the overlap LAP in the up-down direction between the wiper body 110 and the nozzle surface 41A of the head 11 and the distance 1 in the up-down direction between the upper end 111 of the wiper body 110 and the projection 130.

In a case that the wiper 100 moves further toward the one side in the wiping direction (left side) with respect to the head 11 and that the projection 130 is separated from the lower surface of the head 11, the wiper body 110 is restored toward the one side in the wiping direction (left side) further only by an angle θ3 (θ3=θ1−θ2). With this, the wiper body 111 is restored to the state of being parallel to the up-down direction. In such a manner, the wiper body 110 is restored gradually in the two phases after the upper end 111 of the wiper body 110 is separated from the nozzle surface 41A. With this, occurrence of such a situation that the ink which has been wiped from the nozzle surface 41a by the wiping operation and adhered to the first surface 113 of the wiper body 110 is scattered in the surrounding due to the abrupt restoration of the wiper body 110 is lowered.

Note that according to the calculation by the inventors, it is found out that in a case that the height L of the wiper body 110 is 10.5 mm, the overlap LAP in the up-down direction between the wiper body 110 and the nozzle surface 41A of the head 11 is 1.5 mm, and the distance 1 in the up-down direction between the upper end 111 of the wiper body 110 and the projection 130 is 0.4 mm, the angle θ1 is 31.0°, the angle θ2 is 15.9° and the angle θ3 is 15.1°; and that the required height X of the projection 130 from the wiper body 110 is 2.87 mm. Further, it is found out that in a case that the height L of the wiper body 110 is 10.5 mm, the overlap LAP in the up-down direction between the wiper body 110 and the nozzle surface 41A of the head 11 is 1.0 mm, and the distance 1 in the up-down direction between the upper end 111 of the wiper body 110 and the projection 130 is 0.4 mm, the angle θ1 is 25.2° , the angle θ2 is 15.9° and the angle θ3 is 9.3°; and that the required height X of the projection 130 from the wiper body 110 is 2.87 mm. Furthermore, it is found out that in a case that the height L of the wiper body 110 is 10.5 mm, the overlap LAP in the up-down direction between the wiper body 110 and the nozzle surface 41A of the head 11 is 0.5 mm, and the distance 1 in the up-down direction between the upper end 111 of the wiper body 110 and the projection 130 is 0.4 mm, the angle θ1 is 17.8°, the angle θ2 is 15.9° and the angle θ3 is 1.9°; and that the required height X of the projection 130 from the wiper body 110 is 2.87 mm. In such a manner, it is found out that by fixing the height X of the wiper body and by changing the value of the overlap LAP in the up-down direction between the wiper body 110 and the nozzle surface 41A of the head 11, the angles θ1 and θ2 change as described above.

<Effect of Embodiment>

In the above-described embodiment, the head 11 has the lower surface including the nozzle surface 41A in which the nozzles 11a are opened. The wiper 100 is configured to make contact with the nozzle surface 41A of the head 11 and to wipe the nozzle surface 41A. The head holder 6, the driving motor 86, the inion gear 83, the rack gear 84 and the guide 85 are collectively referred to as the driving part. By using the driving part, it is possible to move the head holder 6 (head 11) so that the wiper 100 moves toward the one side in the wiping direction (left side) relative to (with respect to) the head 11 in the state that the wiper 100 makes contact with the nozzle surface 41A. Note that the present disclosure is not necessarily limited to a configuration wherein the head 11 moves in the wiping direction in the state that the wiper 100 is fixed. It is allowable that the wiper 100 is configured to move in the wiping direction in a state that the head 11 stands still, or that both of the head 11 and the wiper 100 are configured to move in the wiping direction.

The wiper 100 is provided with the wiper body 110 having the upper end 111 which is a wiping part configured to wipe the nozzle surface 41A, and the projection 130 which projects from the wiper body 110 toward the other side in the wiping direction (right side). After the upper end 111 of the wiper body 110 is separated from the end part on the one side in the wiping direction (left side) of the nozzle surface 41A, the projection 130 makes contact with the lower surface of the head 11 (the lower surface of the nozzle cover 241).

After the upper end 111 of the wiper body 100 is separated from the end part on the one side in the wiping direction (left side) of the nozzle surface 41A, the projection 130 makes contact with the lower surface of the head 11 (the lower surface of the nozzle cover 241), which in turn suppress occurrence of such a situation that the deformation of the wiper body 110 is restored all at once. With this, the restoring speed of the wiper body 110 is suppressed to thereby suppress the occurrence of such a situation that the ink which has been wiped from the nozzle surface 41a by the wiping operation and adhered to the first surface 113 and the upper end 111 of the wiper body 110 is scattered in the surrounding due to the abrupt restoration of the wiper body 110. By providing the projection 130 as described above on the wiper 100, the restoring force of the wiper body 110 is suppressed. Accordingly, there is no need to provide a member which is different from the wiper 100 separately so as to suppress the restoring force of the wiper body 110, and to suppress the manufacturing cost. Further, since the projection 130 is formed in the second surface 114 on the other side in the wiping direction (right side), the projection 130 does not affect the deformation of the wiper body 110 in a case that the wiper body 110 wipes the nozzle surface 41A. Accordingly, even in a case that the projection 130 is formed so as to suppress the restoring force of the wiper body 110, there is not such a fear that the wiping performance of the wiper 100 might be lowered.

In the above-described embodiment, the wiper body 110 and the projection 130 are produced by being integrally formed. With this, it is possible to suppress the increase in the manufacturing cost of the wiper 130.

In the above-described embodiment, the projection 130 is provided with the upper surface 131a of the base 131 which extends perpendicularly from the second surface 114 on the other side in the wiping direction (right side) of the wiper body 110, and makes contact with the lower surface of the nozzle cover 241 of the head 11. With this, it is possible to wipe the lower surface of the nozzle cover 241 by using the upper surface 131a of the base 131 of the projection 130.

In the above-described embodiment, the supporting part 132 is provided on the projection 130, at the location below the base 131. The upper end of the supporting part 132 is continuously connected to the lower end of the base 131, and the left end of the supporting part 132 is continuously connected to the second surface 114 of the wiper body 110. The supporting part 132 has a shape of trapezoid as seen in the conveying direction, and the length in the wiping direction of the supporting part 132 becomes longer further downward from the lower end of the base 131. By adopting such a configuration, it is possible to support the base 131 of the projection 130 more stably by the supporting part 132.

In the above-described embodiment, the wiper body 110 has the upper end 111 as the wiping part configured to wipe the nozzle surface 41A and the first surface 113. Accordingly, the ink wiped from the nozzle surface 41A by the wiping operation adheres to the first surface 113 of the wiper body 110. Since the plurality of grooves 115 extending in the up-down direction are formed in the first surface 113 of the wiper body 110, it is possible to move the ink adhered to the first surface 113 downward via the plurality of grooves 115. With this, it is possible to suppress the occurrence of such a situation that the ink adhered to the first surface 113 is scattered in the surrounding in a case that the deformation of the wiper body 110 is restored.

In the above-described embodiment, the two projections 130 which project from the second surface 114 of the wiper body 110 are provided on the wiper 100. The two projections 130 are arranged with the spacing distance in the conveying direction orthogonal to the wiping direction. Since the two projections 130 are provided on the wiper 100 in such a manner, it is possible to wipe two locations at a time by using the two projections 130.

Further, the two projections 130 make contact with the nozzle cover 241, rather than making contact with the nozzle surface 41A in the lower surface of the head 11. With this, it is possible to wipe the nozzle cover 241 at the same time with the wiping of the nozzle surface 41A, rather than wiping only the nozzle surface 41A.

In the above-described embodiment, the wiper body 110 has the upper end 111 making contact with the nozzle surface 41A at the time of the wiping, and the stepped parts 112 of which height in the up-down direction is lower than that of the upper end 111. At the time of the wiping, the stepped parts 112 make contact with the nozzle cover 241 which covers the nozzle surface 41A from therebelow. With this, it is possible to perform wiping for the nozzle surface 41A and the nozzle cover 241 at a time during the wiping.

In the present embodiment, in a case that the wiper 100 moves toward the one side in the wiping direction (left side) relative to the head 11 and that the upper end 111 of the wiper body 110 is separated from the nozzle surface 41A, the projections 130 make contact with the lower surface of the nozzle cover 241 before the wiper body 110 becomes to be parallel to the up-down direction. In this case, since the projections 130 do not collide against the nozzle surface 41A, there is not a fear that the projections 130 might damage the nozzle surface 41A.

In the present embodiment, the plurality of grooves 116 extending in the up-down direction and the plurality of grooves 117 extending in the conveying direction are formed in the second surface 114 of the wiper body 110. The plurality of grooves 116 have the effect of moving the ink adhered to the second surface 114 downward, similarly to the plurality of grooves 115. Further, by providing the plurality of grooves 117 on the second surface 114, it is possible to make the wiper body 110 to be easily deformable.

In the present embodiment, the two projecting bars 142 and 143 which are configured to fit to the base part 120 of the wiper 100 are formed in the fixing member 140. Further, the projecting bar 142 of the fixing part 142 is provided with the gap 144 configured to fit to the projecting part 121 of the base part 120 of the wiper 100. Since the base part 120 is inserted between the two projecting bars 142 and 143, there is no such a fear that that the wiper body 110 might be deviated in the up-down direction. Further, since the projecting part 121 of the base part 120 engages with the gap 144 formed in the projecting bar 142, there is not such a fear that the wiper body 110 might be deviated in the conveying direction.

In the present embodiment, each of the first surface 113 and the second surface 114 of the wiper body 110 is a broad wide surface expanding in the conveying direction and the up-down direction. The thickness in the wiping direction of the wiper body 110 becomes thinner further upward. Further, the two projections 130 are arranged to be apart in the both sides in the conveying direction of the second surface 114. Each of the projections 130 has the base 131 and the supporting part 132. The lower end of the supporting part 132 is located below the center in the up-down direction of the second surface 114 of the wiper body 110. Further, the length in the conveying direction of each of the projections 130 is greater than the thickness in the conveying direction of the wiper body 110.

Also in such a case, since after the upper end 111 of the wiper body 110 is separated from the end part on the one side in the wiping direction (left side) of the nozzle surface 41A, the projections 130 make contact with the lower surface of the head 11 (the lower surface of the nozzle cover 241), it is possible to suppress occurrence of such a situation that the deformation of the wiper body 110 is restored all at once. This suppresses the occurrence of such a situation that the ink which has been wiped from the nozzle surface 41A by the wiping operation and adhered to the first surface 113 and the upper end 111 of the wiper body 110 is scattered in the surrounding due to the abrupt restoration of the wiper body 110. Further, by providing the projections 130 as described above on the wiper 100, the restoring force of the wiper body 110 is suppressed. Accordingly, there is no need to provide a member which is different from the wiper 100 separately so as to suppress the restoring force of the wiper body 110, and thus it is possible to suppress the manufacturing cost. Further, since the projections 130 are formed in the second surface 114 on the other side in the wiping direction (right side), the projections 130 do not affect the deformation of the wiper body 110 in a case that the wiper body 110 wipes the nozzle surface 41A. Accordingly, even in a case that the projections 130 are formed so as to suppress the restoring force of the wiper body 110, there is no such a fear that the wiping performance of the wiper 100 might be lowered.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

In the above-described embodiment, the wiper body 110, the base part 120 and the projections 130 of the wiper 100 are integrally formed of the EPDM rubber. The present embodiment, however, is not limited to or restricted by this. For example, it is allowable to form the wiper body 110, the base part 120 and the projections 130 of a perfluoro fluorine rubber, rather than forming the wiper body 110, the base part 120 and the projections 130 of the EPDM rubber. Further, it is not necessarily indispensable that the wiper body 110, the base part 120 and the projections 130 are integrally formed; it is allowable to form the wiper body 110, the base part 120 and the projections 130 by combining separate (individual) members. Furthermore, although the hardness of the wiper member 100 is preferably not less than 70 degrees, it is not necessarily indispensable that the hardness of the wiper body 110 is not less than 70 degrees.

In the above-described embodiment, although the two pieces of the projection 130 are provided, the present disclosure is not necessarily limited to such an aspect. For example, it is allowable that the number (quantity) of the projection 130 may be 1 (one), or not less than 3. Further, the position in the conveying direction of the projection 130 may also be changed as appropriate.

In the above-described embodiment, although the upper surface 131a of the base 131 of the projection 130 and the stepped part 112 are formed to be flush with each other with respect to the up-down direction, the present disclosure it not limited to such an aspect. For example, it is allowable that the projection 130 is arranged so that the upper surface 131a is located below the stepped part 112. Further, in the above-described embodiment, the upper surface 131a of the base 131 and the stepped part 112 are configured to make contact with the nozzle cover 241 and to wipe the nozzle cover 241. The present disclosure, however, is not limited to such an aspect. For example, it is not necessarily indispensable that the nozzle cover 241 is provided on the head 11. In such a case, it is allowable that the stepped part 112 is not provided, and that the upper surface 131a of the base 131 is configured to make contact with the nozzle surface 41A.

In the above-described embodiment, although the ink-jet printer 1 is provided with one piece of the head bar 4, the number (quantity) of the head bar 4 may be plural. Note that the number of the head 11 provided on the head bar 4 is not limited to 10 (ten). Further, the number of the nozzle 11a opened in the nozzle surface 41A, the number of the nozzle row, and the number of the nozzle 11a forming each of the nozzle rows are not limited to the numbers, respectively, as described above. Furthermore, it is also possible to change the number and the arrangement of the individual channel 12 and the driving element 46 as appropriate, in accordance with the number and the arrangement of the nozzle 11a.

It is allowable that the position at which the wiper 110A is attached is not shifted in the wiping direction with respect to the position at which the wiper 100B is attached. Namely, in the maintenance base 82, the attachment position of the wiper 100A and the attachment position of the wiper 100B may be aligned in the wiping direction.

In the above-described embodiment, although the wiper 100A and the wiper 100B are provided as the separate members, the present disclosure is not limited to this. For example, the wiper 100A and the wiper 100B may be formed or molded as one member by connecting an end part on the one side in the conveying direction (end of the rear side) of the wiper 100A and an end part on the other side in the conveying direction (end part on the front side) of the wiper 100B are connected by a connecting part.

In the above-described embodiment, the head holder 6 is supported by the rack gear 84 and the guide 85 which are arranged on the one side in the conveying direction (rear side) with respect to the head holder 6, the present disclosure in not limited to this. For example, it is allowable to further provide a guide extending in the wiping direction on the other side in the conveying direction (front side) with respect to the head holder 6, and to support an end part on the other side in the conveying direction of the head holder 6 with this guide. In this case, it is also allowable to provide, on the end part on the other side in the conveying direction on the lower surface of the head holder 6, a roller which is slidable along the added guide.

Further, it is allowable to arrange an absorbing member, for example such as a sponge, etc., configured to absorb the ink adhered to the first surface 113 of the wiper body 110, on the fixing member 140 of the wiper 100.

In the above-described embodiment, the channel unit 42 of each of the heads 11 is provided with the actuator unit 40 having the 1680 driving elements 46 corresponding, respectively to the 1680 individual channels 12. The present disclosure, however, is not limited to such an aspect. For example, it is allowable to provide, on the channel unit 42, a heater configured to bump the ink inside each of the individual channels 12 so as to discharge the ink from the nozzle 11a, instead of the actuator unit 40.

The medium M is not limited to the paper such as the print paper; the medium M may be, for example, a film formed of a resin, cloth, etc.

What is claimed is:

1. A liquid discharge apparatus comprising:
a head including a lower surface including a nozzle surface in which a nozzle is opened;
a wiper configured to make contact with the nozzle surface of the head and to wipe the nozzle surface; and
a driving part configured to drive at least one of the wiper and the head so as to cause the wiper to move relative to the head toward one side in a wiping direction in a state that the wiper makes contact with the nozzle surface, wherein
the wiper includes:
a wiper body including a wiping part configured to wipe the nozzle surface; and
a projection projecting from the wiper body toward the other side in the wiping direction, and
after the wiping part of the wiper body is separated from an end part on the one side in the wiping direction of the nozzle surface, the projection is configured to make contact with the lower surface of the head.

2. The liquid discharge apparatus according to claim 1, wherein
the wiper body and the projection are integrally formed.

3. The liquid discharge apparatus according to claim 1, wherein
the projection includes a contact surface which extends perpendicularly from a surface on the other side in the wiping direction of the wiper body, and which makes contact with the lower surface of the head.

4. The liquid discharge apparatus according to claim 3, wherein
the projection includes a supporting part including the contact surface and expanding downward from the contact surface, and
a length in the wiping direction of the supporting part becomes shorter toward further downward from the contact surface.

5. The liquid discharge apparatus according to claim 1, wherein
the wiping part of the wiper body is a surface on the one side in the wiping direction of the wiper body.

6. The liquid discharge apparatus according to claim 1, wherein
the projection is arranged on one side, of the wiper body, in a direction crossing the wiping direction, and
the wiper further includes another projection having a shape same as that of the projection and arranged on the other side, of the wiper body, in the direction crossing the wiping direction.

7. The liquid discharge apparatus according to claim 6, wherein
each of the projection and the another projection makes contact with an area, of the lower surface, which is different from the nozzle surface.

8. The liquid discharge apparatus according to claim 7, wherein
the head includes:
a nozzle plate including the nozzle surface, and
a nozzle cover configured to cover a surrounding of the nozzle surface of the nozzle plate from below,
the wiper body includes a first area overlapping with the nozzle surface in an up-down direction, and a second area overlapping with the nozzle cover at the surrounding of the nozzle surface in the up-down direction, and
a height in the up-down direction of the second area is lower than that of the first area.

9. The liquid discharge apparatus according to claim 8, wherein
the projection and the another projection project from the second area of the wiper body toward the other side in the wiping direction, and make contact with the nozzle cover.

10. The liquid discharge apparatus according to claim 1, wherein
a groove is formed in a surface on the other side in the wiping direction of the wiper body.

11. The liquid discharge apparatus according to claim 1, wherein
the wiper has a fixing member configured to fix the wiper body, and
a projecting part or a recessed part is formed at a part, of the wiper body, which is located below the wiping part, the projecting part or the recessed part being configured to fit to the fixing part so as to position the wiper body with respect to the fixing part.

12. A wiper for a liquid discharge apparatus comprising:
a wiper body including a wiping part extending in a first direction and configured to make contact with a nozzle surface and to wipe the nozzle surface, the nozzle surface being included in a lower surface possessed by a head, and a nozzle being opened in the nozzle surface; and
a projection projecting from the wiper body toward one side in a second direction crossing the first direction, wherein
in a case that the wiper body is moved toward the other side in the second direction in a state that the wiping part of the wiper body makes contact with the nozzle surface, the projection is configured to make contact with the lower surface of the head after the wiping part of the wiper body is separated from an end part on the other side in the second direction of the nozzle surface.

13. A wiper for a liquid discharge apparatus comprising:
a wiper body having a plate shape and including a surface expanding in a first direction and a second direction orthogonal to the first direction, a thickness in a third direction orthogonal to the first direction and the second direction of the wiper body becoming slenderer further toward one side in the first direction; and
a pair of projections arranged, respectively, on both sides in the second direction of the wide surface of the wiper body, wherein
the pair of projections project in the third direction over a range from a middle point in the first direction of the wide surface and up to a forward end in the first direction of the wide surface, and a length in the third direction of the pair of projections is greater than a thickness in the third direction of the wiper body.
